(19) United States
(12) Patent Application Publication
(10) Pub. No.: US 2012/0055568 A1
(43) Pub. Date: Mar. 8, 2012

(54) Extractor Device For An Aqueous Fluid In A Motor Vehicle

(75) Inventors: Jörg Friedel, Wenzenbach/Grunthal (DE); Karl Smirra, Wasserburg (DE)

(73) Assignee: Continental Automotive GmbH, Hannover (DE)

(21) Appl. No.: 13/260,707

(22) PCT Filed: Mar. 25, 2010
(86) PCT No.: PCT/EP2010/053909

§ 371 Date: Nov. 17, 2011

(30) Foreign Application Priority Data
Mar. 31, 2009 (DE) 10 2009 015 124.9

(51) Int. Cl. B01D 47/00

(52) U.S. Cl. 137/565.17

(57) ABSTRACT

The invention relates to an extractor device for an aqueous fluid from a storage container of a motor vehicle wherein a lengthwise-extended heating element is arranged next to a venting tube. The venting tube connects a catch container to a chamber arranged above the fluid level in the storage container. In case of icing, a connection is created early from the catch container to the chamber. A pump can thus convey the fluid out of the catch container early.

### CROSS REFERENCE TO RELATED APPLICATION

This is a U.S. national stage of application No. PCT/EP2010/053909, filed on 25 Mar. 2010. Priority is claimed on Germany Application No. 10 2009 015 124.9, filed 31 Mar. 2009 the content of which are incorporated here by reference.

### BACKGROUND OF THE INVENTION

1. Field of the Invention

The invention relates to an extractor device for an aqueous fluid in a motor vehicle with a storage container for storing the fluid and a pump for conveying the solution out of a catch container arranged in the bottom region of the storage container.

2. Description of the Related Art

Extractor devices of this type serve in modern motor vehicles to convey an aqueous urea solution and are known in industry. The fluid is required to reduce nitrogen emissions. The extractor device known in industry has at least one heating device arranged in the storage container in to prevent the aqueous fluid forming ice at low temperatures. However, when the fluid is completely frozen, there is a risk, when the heating devices are started, of an ice cavity forming in the suction region of the pump and of fluid recycled to the storage container not passing to the suction region of the pump again. In addition, the pump can only convey fluid out of an ice cavity when followed by air or fluid.

It could be conceivable to continuously heat up the entire storage container. However, this requires a very high outlay on energy and apparatus. In addition, the heating-up requires time, thus delaying the beginning of the conveying by the extractor device.

### SUMMARY OF THE INVENTION

The invention is based on the problem of developing an extractor device of the type mentioned at the beginning in such a manner that it reliably ensures that conveying will begin as rapidly as possible after the fluid in the storage container has frozen.

This problem is solved according to one embodiment of the invention in that a lengthwise-extended heating element connects the catch container to a chamber arranged above the maximum fluid level in the storage container.

This configuration makes it possible for the lengthwise-extended heating element to permit the formation of an ice-free channel from the catch container to above the maximum fluid level when the fluid has completely frozen in the storage container. The lengthwise-extended heating element prevents the production of a closed ice cavity in the suction region of the pump. By this heating element, the fluid drawn off by the pump can be replaced at any time by air or by thawed fluid flowing back. Since the formation of the ice-free channel begins directly after the lengthwise-extended heating element has been switched on, the configuration according to the invention of the extractor device permits a particularly rapid beginning of the conveying after the fluid has frozen in the storage container. The chamber is preferably connected to the surroundings via a venting valve, and therefore the fluid that is removed from the container can be replaced by air flowing in after.

According to an advantageous development of the invention, a particularly specific thawing of a designated amount of fluid can be ensured if the lengthwise-extended heating element is arranged in a venting tube. According to one embodiment of the invention, fluid thawed by the heating element or kept fluid penetrates the venting tube. The venting tube has an appropriate volume for storing a limited quantity of fluid to be conveyed. Fluid that has thawed in the venting tube can only flow into the catch container and can therefore be drawn up in a simple manner. Owing to the invention, the venting tube permits reliable venting and supply of a designated quantity of fluid to ensure a rapid start of operation of the extractor device in the iced state.

Freezing of the upper end of the venting tube can be avoided in a simple manner, according to another advantageous development of the invention, if the upper border of the storage container has a cup-shaped, downwardly open container, and if that end of the venting tube that faces away from the catch container projects into the cup-shaped container. The downwardly open container ensures that, after the pump has been switched off, the upper end of the venting tube reliably projects above the fluid level. Air can therefore reliably flow in when the fluid is drawn out of the catch container.

A plurality of chambers separated from one another in the storage container can be avoided in a simple manner, according to another advantageous development of the invention, if a suction connection of the pump projects directly into the catch container of the storage container. By this suction connection, the extractor device according to one embodiment of the invention is constructed particularly simply manner.

The conveying of the fluid is further accelerated when the storage container is iced if the lengthwise-extended heating element is arranged directly adjacent to the suction connection and/or to a pressure pipe of the pump.

A sufficient quantity of heated liquid is available to the pump after a particularly short time if the catch container has heating below the venting tube and the suction connection of the pump. This configuration permits a particularly rapid conveying of fluid out of a frozen storage container.

The extractor device according to one embodiment of the invention is structurally particularly simple if the lengthwise-extended heating element is guided into the bottom region of the catch container. The heating element can either be placed or pressed into the venting tube.

The mounting of the extractor device according to one embodiment of the invention is further simplified if the storage container has an inwardly protruding, encircling edge, if the inner border of the edge is closed by a mounting flange, and if the mounting flange and the edge form the cup-shaped, downwardly open container.

The outlay on sealing the components of the extractor device according to one embodiment of the invention can be kept particularly low if the pump is arranged within the storage container, and if the pressure pipe is guided through the mounting flange for the connection of a conveying line. Since the pressure pipe can be manufactured integrally with the mounting flange, the required sealing is restricted in the simplest case to the mounting flange and to electric connections for the pump and the heating elements. A filler neck with a conventional venting valve for the storage container is preferably arranged next to the mounting flange.

The mounting of the components of the extractor device according to one embodiment of the invention is simplified if the venting tube and the suction connection and/or the pressure pipe of the pump are designed as a constructional unit.

The mounting of the components of the extractor device according to one embodiment of the invention is further simplified if the pump is arranged outside the storage container.

An excess of the fluid conveyed by the pump is generally recycled to the storage container. According to an advantageous development of the invention, the excess of conveyed fluid can be directly drawn up again if the venting tube is connected to a return channel. This prevents thawed fluid, in the case of an iced extractor device, being lost in the storage container and no longer being available for direct drawing up again.

The venting tube permits the rapid supply of a quantity of ice-free fluid sufficient for the first operation of the motor vehicle if the venting tube has a volume of at least 100 ml. The venting tube therefore serves as a storage chamber in which a defined quantity of fluid is rapidly thawed and kept available. The volume of the venting line suffices in order cover the consumption of aqueous urea solution in most motor vehicles for the first 1000 km.

### BRIEF DESCRIPTION OF THE DRAWINGS

The invention permits numerous embodiments. To further clarify the basic principle thereof, two of the embodiments are illustrated in the drawing and are described below. In the drawing.

FIG. 1 is a schematic illustration of an extractor device according to one embodiment of the invention;

FIG. 2 is a sectional illustration of the extractor device according to FIG. 1;

FIG. 3 is an enlarged sectional illustration through a venting tube and a pressure pipe of the extractor device from FIG. 2 along the line III-III,

FIG. 4 is a further embodiment of the extractor device according to FIG. 1.

### DETAILED DESCRIPTION OF THE PREFERRED EMBODIMENTS

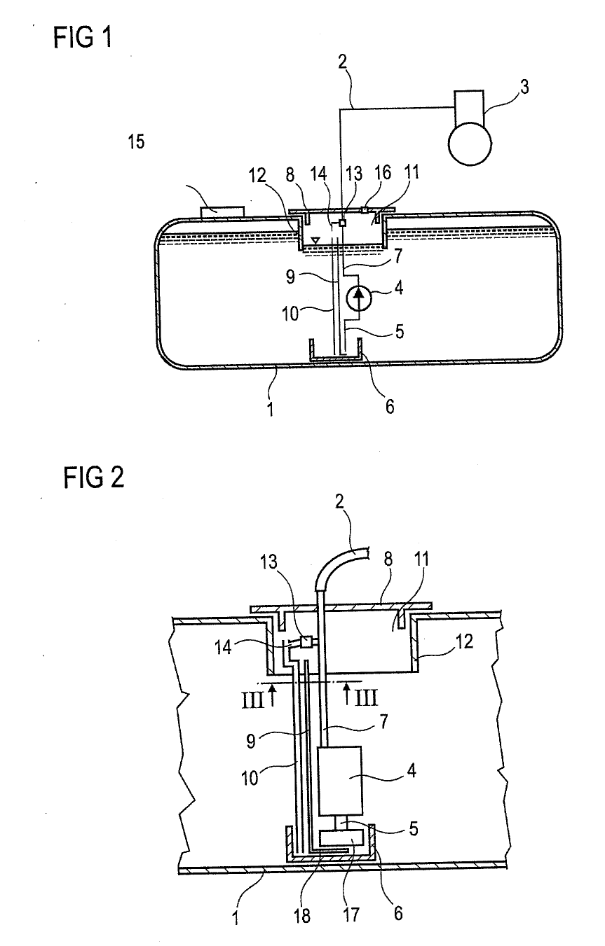

FIG. 1 shows an extractor device with a storage container 1 for storing an aqueous fluid, in particular a urea solution, and with a conveying line 2 for guiding conveyed fluid to an internal combustion engine 3 of a motor vehicle. The extractor device has a pump 4 for drawing fluid out of the storage container 1. A suction connection 5 of the pump 4 is guided into a catch container 6 arranged in the bottom region of the storage container 1. A pressure pipe 7 connected to the pressure side of the pump 4 passes through a mounting flange 8 of the storage container 1 and is connected to the conveying line 2. Furthermore, a heating element 9 and a venting tube 10 are guided from the storage container 1 into a chamber 11 arranged above the fluid level. The heating element 9 is configured to extend lengthwise and, when energized, emits heat over its entire length. In order to form the chamber 11, the storage container 1 has an encircling edge 12 protruding into the interior. The region surrounded by the edge 12 is sealed by the mounting flange 8. It is therefore ensured that, even despite the storage container 1 being fully filled, the fluid level does not rise above the lower border of the edge 12 into the chamber 11. A return channel 14, which is controlled by a pressure control valve 13, is connected to the pressure pipe 7 and is guided to a point above the venting tube 10. In addition, the storage container 1 has a filler neck 15. The chamber 11 is also connected to the surroundings via a venting valve 16, which is a nonreturn valve, and therefore fluid removed from the storage container 1 can be replaced by air.

Fluid that has completely frozen in the storage container 1 is thawed in the surroundings of the heating element 9 after the heating element 9 has been energized. Thus, even fluid located in the venting tube 10 and the catch container 6 is thawed, and a connection of the catch container 6 to the chamber 11 is ensured. The fluid in the venting tube 10 is directly available to the pump 4 for conveying. Fluid recycled via the return channel 14 is likewise directly supplied again to the pump 4 via the venting channel 10.

FIG. 2 shows, in a sectional illustration through the extractor device from FIG. 1, that the pump 4 is arranged within the storage container 1. The pressure pipe 7 penetrates the mounting flange 8. A filter 17, below which a horizontal portion 18 of the heating element 9 projects, is arranged on the suction connection 5 of the pump.

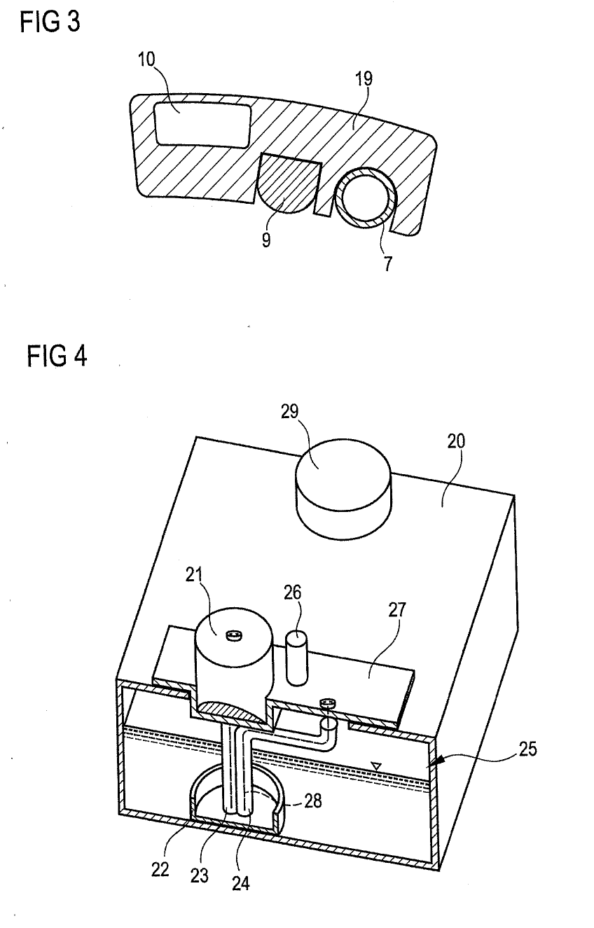

FIG. 3 shows, in a sectional illustration along the line III-III through the venting tube 10, that the heating element 9 is arranged between pressure pipe 7 and venting tube 10. Therefore, when the heating element 9 is energized, both venting tube 10 and pressure pipe 7 are heated. The pressure pipe 7 and the heating element 9 are pressed in a profile 19 forming the venting tube 10.

FIG. 4 shows a sectional illustration through a further embodiment of the extractor device with a pump 21 arranged on an outer side of a storage container 20. The pump 21 has a suction connection 23 guided into a catch container 22. The suction connection 23 is manufactured integrally with a venting tube 24. The venting tube 24 connects a chamber 25, which is arranged in the storage container 20 above the fluid level, to the catch container 22. A pressure pipe 26, which is connected to the pressure side of the pump 21 penetrates a mounting flange 27 of the storage container 20. A heating element 28, illustrated by dashed lines in FIG. 4, is guided through the venting tube 24 into the catch container 22 and from there via the suction connection 23 as far as the pump 21. The heating element 28 is configured to extend lengthwise. When the heating element 28 is energized, fluid that has frozen in the venting tube 24 and in the suction connection 23 is thawed. The storage container 20 also has a filler neck 29 for the topping up of fluid.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. An extractor device for an aqueous fluid in a motor vehicle, comprising:
a storage container for storing the aqueous fluid;
a catch container arranged in the bottom region of the storage container;
a pump configured to convey the aqueous fluid out of the catch container; and
a vertically lengthwise-extending heating element that connects the catch container to a chamber arranged above a maximum fluid level in the storage container.

15. The extractor device as claimed in claim 14, wherein the vertically lengthwise-extending heating element is arranged in a venting tube.

16. The extractor device as claimed in claim 15, further comprising:
a cup-shaped, vertically downward open container arranged at an upper border of the storage container,
wherein an end of the venting tube that faces away from the catch container projects into the cup-shaped container.

17. The extractor device as claimed in claim 15, wherein a suction connection of the pump projects directly into the catch container.

18. The extractor device as claimed in claim 17, wherein the vertically lengthwise-extending heating element is arranged directly adjacent to one of the suction connection and a pressure pipe of the pump.

19. The extractor device as claimed in claim 17, wherein the catch container has a heating element arranged below the venting tube and the suction connection of the pump.

20. The extractor device as claimed in claim 14, wherein the vertically lengthwise-extending heating element is guided into a bottom region of the catch container.

21. The extractor device as claimed in claim 16, wherein the storage container comprises:
an inwardly protruding encircling edge, an inner border of the edge is closed by a mounting flange,
wherein the mounting flange and the edge form the cup-shaped, vertically downward open container.

22. The extractor device as claimed in claim 21, wherein the pump is arranged within the storage container, and the pressure pipe is guided through the mounting flange and configured for connection of a conveying line.

23. The extractor device as claimed in claim 18, wherein one or more of the venting tube, the suction connection, and the pressure pipe of the pump are a constructional unit.

11. The extractor device as claimed in claim 14, wherein the pump is arranged outside the storage container.

24. The extractor device as claimed in claim 15, wherein the venting tube is connected to a return channel.

25. The extractor device as claimed in claim 15, wherein the venting tube has a volume of at least 100 ml.
